(19) United States
(12) Patent Application Publication
(10) Pub. No.: US 2016/0027543 A1
(43) Pub. Date: Jan. 28, 2016

(54) METHOD FOR MANUFACTURING SOLIDIFIED BODY OF RADIOACTIVE WASTE AND MANUFACTURING APPARATUS FOR SOLIDIFIED BODY

(71) Applicant: KABUSHIKI KAISHA TOSHIBA, Minato-Ku (JP)

(72) Inventors: Yusuke NOHARA, Ota (JP); Shohei KAWANO, Yokohama (JP); Akio SAYANO, Yokohama (JP); Masamichi OBATA, Shinagawa (JP); Ryota TAKAHASHI, Shinagawa (JP)

(73) Assignee: KABUSHIKI KAISHA TOSHIBA, Minato-Ku (JP)

(21) Appl. No.: 14/806,149

(22) Filed: Jul. 22, 2015

(30) Foreign Application Priority Data
Jul. 22, 2014 (JP) 2014-148748

(51) Int. Cl. G21F 9/30

(52) U.S. Cl. CPC G21F 9/302

(57) ABSTRACT

A method for manufacturing a solidified body of a radioactive waste includes a kneading step (S12 to S18) for kneading, together with a molding adjuvant, an inorganic adsorbent adsorbing radionuclides to generate a kneaded body, an adjusting step (S14 to S17) for adjusting a water content of the kneaded body to be within a predetermined range, a molding step (S19) for molding the kneaded body by extruding, a cutting step (S20) for cutting, at a specified interval, the kneaded body extruded in a bar shape, and a baking step (S22) for baking the cut kneaded body into a solidified body.

### BACKGROUND OF THE INVENTION

1. Field of the Invention

The present invention relates to a technique for manufacturing a solidified body of an inorganic adsorbent with adsorbed radionuclides.

2. Description of the Related Art

An atomic power plant has a cycle of water passing through a steam generating unit, a high-pressure turbine, a low-pressure turbine, a condenser, a water supply pump, and a feed water heater in this order and the light water returning to the steam generating unit.

The high-pressure turbine and the low-pressure turbine are driven by steam generated by the steam generating unit to actuate a generator for generating electric power.

In a boiling water reactor power plant (BWR), a reactor boils light water. The reactor functions as the steam generating unit as well.

If all power supplies to the BWR are lost by a large earthquake or a large tsunami, water supply to the reactor stops and the reactor is heated without water.

When the reactor is continuously heated without water, melting of a core fuel or damage to a reactor pressure vessel may be caused.

Meanwhile, when such a severe accident occurs, cooling water is supplied to the inside of the reactor pressure vessel from the outside in order to stably cool decay heat of the core fuel.

If the reactor pressure vessel suffers damage when the cooling water is supplied, the supplied contaminated cooling water which contains radioactive nuclear leaks from the damaged part.

To purify a large amount of high-concentration radioactively contaminated water, radionuclides are to be removed using an adsorbent such as an inorganic adsorbent.

In such purification treatment using the adsorbent, radioactive wastes of the adsorbent and the like are secondarily generated.

When it is assumed that the core fuel is melted, the secondary wastes contain high-concentration radioactive cesium (¹³⁷Cs) and the like and show a high radiation dose.

For interim storage in a long term and final disposal of the radioactive wastes, it is therefore necessary to solidify the radioactive wastes and keep the radioactive waste in a stable state.

Several solidifying techniques for inorganic adsorbents containing radionuclides such as ¹³⁷Cs and strontium have been disclosed.

For example, the radionuclides are adsorbed by an inorganic adsorbent such as synthetic mordenite, pressurized and molded by a rubber press, baked in an atmospheric furnace at temperature of about 1200° C. for solidification.

There has also been disclosed a technique for adding an alkali water solution to a ceramic waste including a radioactive substance, filling the ceramic waste and the alkaline water solution in a metal capsule, and subjecting the entire ceramic waste to hot isostatic pressing treatment to thereby mold a solidified body. To grasp the technical background, for example, Japanese Patent No. 2807381 or Japanese Patent No. 3071513 is of use as a reference.

When the radionuclides are, however, baked at high temperature of about 1200° C., volatilization of ¹³⁷Cs adsorbed by the inorganic adsorbent is anticipated.

For example, when the radionuclides are retained for three hours at 1200° C., a volatilization rate of ¹³⁷Cs adsorbed by the inorganic adsorbent is 0.02 to 0.22%.

When the ceramic waste containing the radioactive substance is filled in the metal capsule together with the alkali water solution, a large mechanical facility has to be used to perform the hot isostatic pressing treatment.

Further, since it takes a long time, the treatment is not suitable for treating a large amount of wastes.

### SUMMARY OF INVENTION

To solve the problem, an object thereof is to provide a method for manufacturing a solidified body of a radioactive waste and a manufacturing apparatus for the solidified body that enable stable final disposal of a large amount of radionuclides in a simple process and suppress volatilization of the radionuclides in manufacturing of the solidified body.

A method for manufacturing a solidified body of a radioactive waste according to the present invention includes: a kneading step for kneading, together with a molding adjuvant, an inorganic adsorbent adsorbing a radionuclide to generate a kneaded body; an adjusting step for adjusting a water content of the kneaded body to be within a predetermined range; a molding step for molding the kneaded body by extruding; a cutting step for cutting, at a specified interval, the kneaded body extruded in a bar shape; and a baking step for baking the cut kneaded body into a solidified body.

A manufacturing apparatus for a solidified body of a radioactive waste according to the present invention includes: a kneading machine that kneads an inorganic adsorbent adsorbing a radionuclide and a molding adjuvant to generate a kneaded body; an adjusting unit that adjusts an amount of water to be kneaded together with the inorganic adsorbent and the molding adjuvant; a hollow tank that has a mold hole and houses the kneaded body; an extruding unit that extrudes the kneaded body from the mold hole and molds the kneaded body; a cutting unit that cuts, at a specified interval, the kneaded body extruded in a bar shape; and a baking furnace that bakes the cut kneaded body into a solidified body.

According to the present invention, the method for manufacturing a solidified body of a radioactive waste and the manufacturing apparatus for the solidified body are provided that enable stable final disposal of a large amount of radionuclides in a simple process and suppress volatilization of the radionuclides in manufacturing of the solidified body.

### BRIEF DESCRIPTION OF THE DRAWINGS

FIG. 1 is a schematic configuration diagram of a manufacturing apparatus for a solidified body of a radioactive waste according to a first embodiment;

FIG. 2 is an enlarged sectional view of a kneading machine of a manufacturing apparatus according to first embodiment and various members connected to a kneading machine;

FIG. 3 is a schematic sectional view showing an example of an adjusting unit in which a measuring unit is set on the outside of a kneading machine;

FIG. 4 is an enlarged sectional view of an example of an adjusting unit where a measuring unit provided outside of a kneading machine;

FIG. 5 is an outlet and an inlet may be directly connected via a pipe by welding or the like;

FIG. 6A is a diagram showing an experiment result obtained by measuring density of a cut body, for which chabazite is used as an inorganic adsorbent, using a retention temperature during baking;

FIG. 6B is a diagram showing an experiment result obtained by measuring density of a cut body, for which crystalline silicon titanate is used as an inorganic adsorbent, using a retention temperature during a baking;

FIG. 7 is a flowchart of a method for manufacturing a solidified body of a radioactive waste (hereinafter simply referred to as “manufacturing method”) according to first embodiment;

FIG. 8 is a flowchart of a manufacturing method according to a second embodiment;

FIG. 9 is a schematic configuration diagram of a manufacturing apparatus according to the second embodiment;

FIG. 10 is a schematic configuration diagram of a manufacturing apparatus according to a third embodiment;

FIG. 11 is a schematic sectional view showing an example of an arrangement of a kneading machine and exhaust pipes in the extrusion molding machine;

FIG. 12 is an enlarged sectional view of a kneading machine of a manufacturing apparatus according to a fourth embodiment and various members connected to a kneading machine;

FIG. 13 is an example concerning a solidified body of radioactive wastes according to an embodiment; and

FIG. 14 is a table showing experiment data obtained by manufacturing a solidified body by kneading a molding adjuvant, which is kaolin, with an inorganic adsorbent.

### DESCRIPTION OF THE PREFERRED EMBODIMENT

Hereunder, embodiments are explained below with reference to the drawings.

### First Embodiment

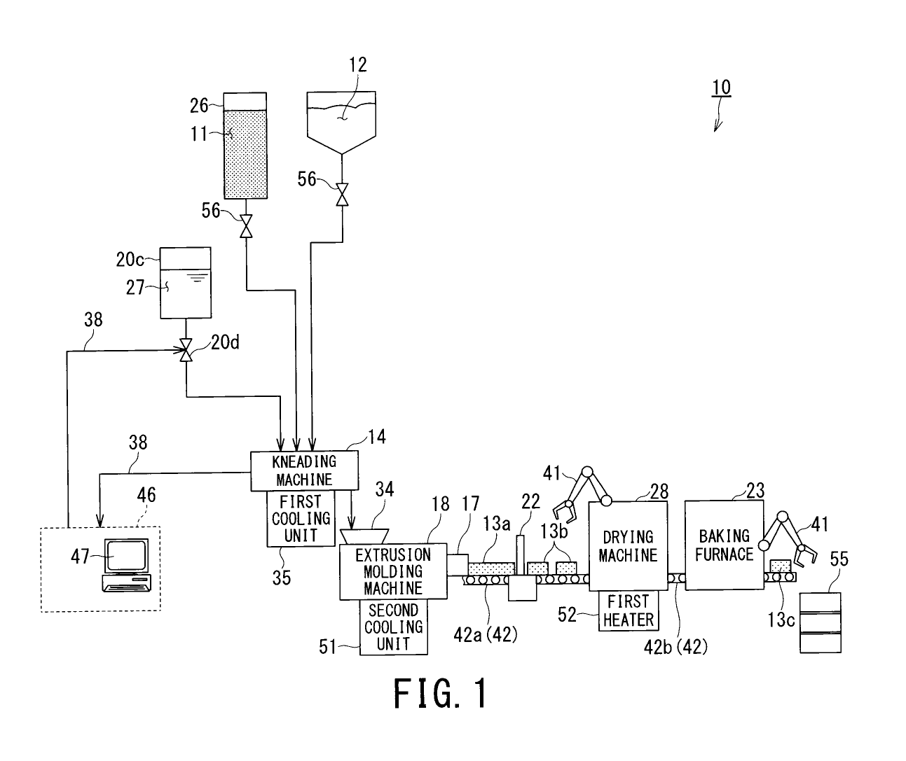

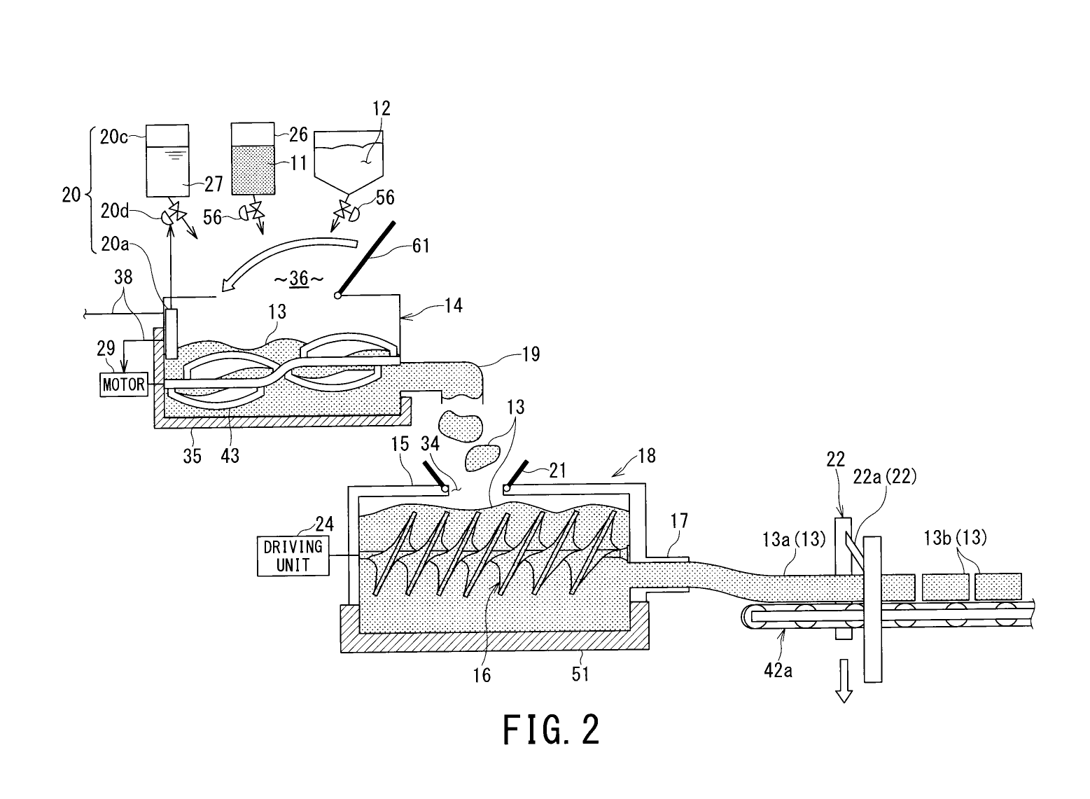

With reference to FIGS. 1 and 2 showing a manufacturing apparatus 10 for a solidified body of a radioactive waste (hereinafter simply referred to as “manufacturing apparatus 10”) (FIG. 1) and a kneading machine 14 (FIG. 2) of the manufacturing apparatus 10 according to the first embodiment and various members connected to the kneading machine 14, the manufacturing apparatus 10 according to the first embodiment includes the kneading machine 14 that kneads the inorganic adsorbent 11 adsorbing radionuclides and the molding adjuvant 12 to generate the kneaded body 13, an adjusting unit 20 that adjusts the amount of water to be kneaded together with the inorganic adsorbent 11 and the molding adjuvant 12, a hollow tank 15 that has a mold hole 17 and houses the kneaded body 13, an extruding unit 16 that extrudes the kneaded body 13 from the mold hole 17 of the hollow tank 15 and molds the kneaded body 13, a cutting unit 22 that cuts, at a specified interval, the kneaded body 13a extruded in a bar shape, and a baking furnace 23 that bakes the cut kneaded body (the cut body) 13b into the solidified body 13c.

The kneading machine 14 kneads the inorganic adsorbent 11 adsorbing radionuclides and the molding adjuvant 12 to generate the kneaded body 13.

The inorganic adsorbent 11 and the molding adjuvant 12 are kneaded together with water 27 by a kneading impeller 43 rotated by a motor 29.

An inorganic adsorbent containing chabazite or crystalline silicon titanate as a main component is suitably used as the inorganic adsorbent 11.

The inorganic adsorbent 11 is not limited to the above and may be aluminum silicate, clinoptilolite, herschelite or the like having a characteristic of adsorbing a radioactive substance.

The inorganic adsorbent 11 is used in, for example, an absorption tower installed in a nuclear power plant.

In the absorption tower, the inorganic adsorbent 11 is housed in a plurality of vessels 26 connected in series and adsorbs radionuclides from radioactively contaminated water passed through the vessels 26.

When the radioactively contaminated water is passed through the vessel group connected in series for a predetermined time, a most upstream (first) vessel 26 is removed, and a second vessel 26 shifts to replace the most upstream vessel 26. A new vessel 26 is added in the most downstream side.

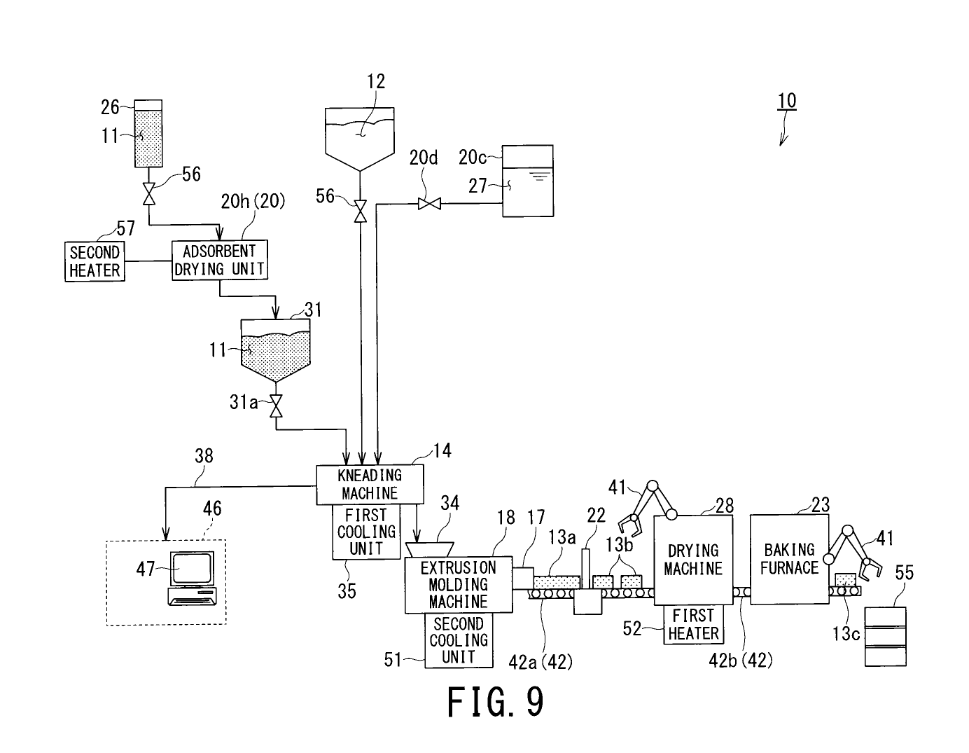

In general, the inorganic adsorbent 11 of the removed vessel 26 is kept housed in the vessel 26 or collected in an adsorbent hopper 31 (FIG. 9) and temporarily stored.

The inorganic adsorbent 11 stored in this way is put in the kneading machine 14 and kneaded together with the molding adjuvant 12 and the water 27.

Since the inorganic adsorbent 11 is housed in the vessels 26 through which the radioactively contaminated water is passed, the inorganic adsorbent 11 often already contains a certain degree of moisture.

When the inorganic adsorbent 11 is put in the kneading machine 14, if a moisture content of the inorganic adsorbent 11 is equal to or larger than an amount of the water 27 to be supplied, the water 27 does not have to be supplied.

The molding adjuvant 12 is added to the inorganic adsorbent 11 and kneaded to give plasticity to the inorganic adsorbent 11 in a powder state and facilitate extrusion molding.

A molding adjuvant containing a clay-base mineral as a main component is suitably used as the molding adjuvant 12.

Examples of the applied molding adjuvant 12 of the clay-base mineral include bentonite, kaolin (kaolinite), halloysite, chrysotile, pyrophylitte, talc, muscovite, phlogopite, sericite, chlorite, beidellite, and vermiculite.

In particular, bentonite and kaolin are inexpensively easily available and can be suitably used.

Note that, in the kneading, the temperature of the kneaded body 13 may exceed 100° C. because of frictional heat and nuclear decay of radionuclides due to the kneading.

If the kneading is continued at such high temperature, a frequency of deterioration or failure of the kneading machine 14 and the various machines connected to the kneading machine 14 increases.

If the temperature of the kneaded body 13 is not controlled, it is also difficult to adjust the water 27 taking into account vaporization of moisture.

Accordingly, a first cooling unit 35 is provided in the kneading machine 14 to maintain the temperature of the kneaded body 13 at about 50° C.

The adjusting unit 20 adjusts the amount of water to be kneaded together with the inorganic adsorbent 11 and the molding adjuvant 12.

When the kneaded body 13 is molded by extrusion molding, to prevent a crack from occurring in the extrusion-molded body 13a formed by the extrusion molding and maintain an appropriate shape, it is necessary to set the water content of the kneaded body 13 after the kneading to appropriate water content.

A range of the appropriate water content of the kneaded body 13 after the kneading is narrow. For example, when the molding adjuvant 12 is bentonite, the appropriate water content is about 35%±0.3%.

When the molding adjuvant 12 is kaolin, the width of the appropriate range of the water content is as narrow as about ±0.3%.

That is, in order to maintain a necessary addition amount of the molding adjuvant 12 at a minimum amount and generate the kneaded body 13a having viscosity suitable for the extrusion molding, it is important to adjust the water content of the kneaded body 13.

The manufacturing apparatus 10, therefore, includes the adjusting unit 20 and adjusts the water content of the kneaded body 13.

The adjusting unit 20 includes, for example, a measuring unit 20a (20) that measures a water content of the kneaded body 13 in the kneading machine 14 and a water supply unit 20c (20) that is connected to the kneading machine 14 and supplies the water 27 to the kneading machine 14.

As the measuring unit 20a, for example, a moisture meter based on a four-electrode method, which is a type of an electric resistance method, a moisture meter based on a capacitance method, or a moisture meter based on a dielectric method can be used.

Note that all of these moisture meters need to correct a measurement value taking into account nuclear decay of radionuclides.

The measuring unit 20a may be set on the outside of the kneading machine 14.

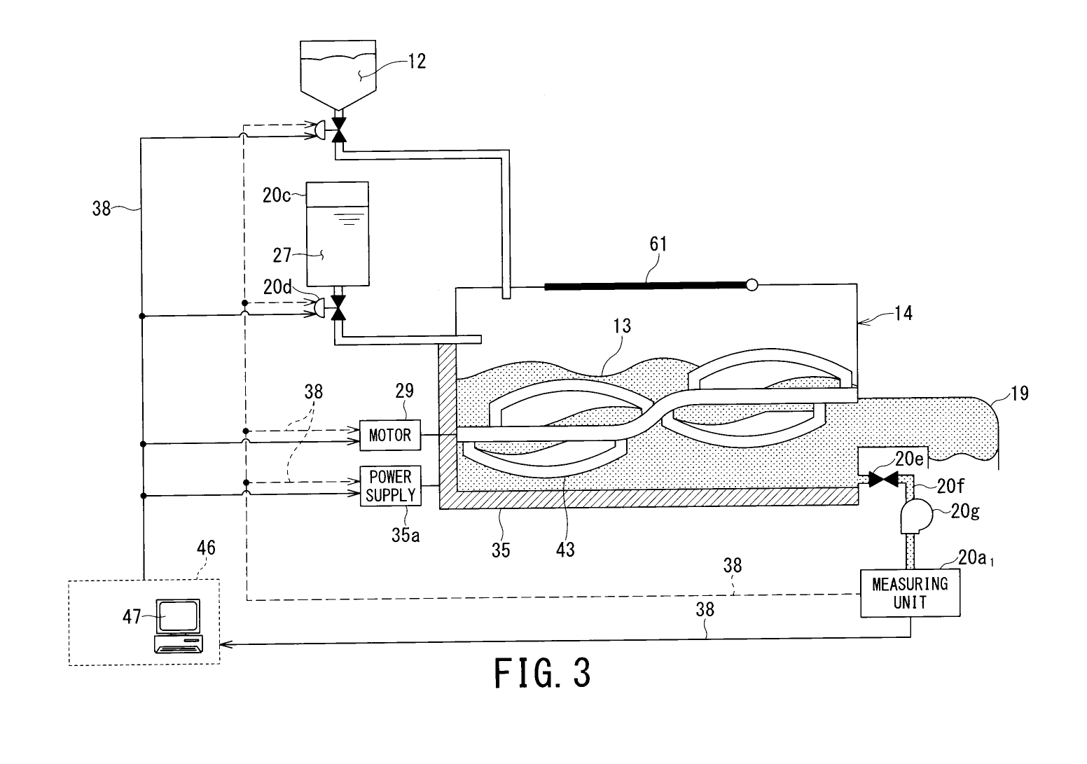

For example, FIG. 3 is a schematic sectional view showing an example of the adjusting unit 20 in which the measuring unit 20a is set on the outside of the kneading machine 14.

As shown in FIG. 3, the measuring unit 20a may be an infrared measuring unit 20a1 (20a) that is set on the outside of the kneading machine 14 and measures a water content of a collected sample.

The infrared measuring unit 20a1 dries the sample with an infrared ray and measures a water content of the sample from a change in the mass of the sample before and after the drying.

The sample is sent to the infrared measuring unit 20a1 from, for example, a sampling pipe 20f (20) provided in the vicinity of an outlet 19 of the kneading machine 14.

In the sampling pipe 20f, a sampling valve 20e (20), which is normally closed, and a sampling pump 20g (20) are set.

When the kneaded body 13 is kneaded for a predetermined time, a part of the kneaded body 13 near the outlet 19 is sucked and collected by the sampling pump 20g.

A measurement value of the water content measured by the measuring unit 20a is transmitted to, for example, a control room 46 on the outside of the manufacturing apparatus 10 through a line 38 and monitored by a monitoring person.

Upper limit and lower limit thresholds are set for the measurement value to be transmitted. When the measurement value exceeds the thresholds, notification is displayed on a monitor 47.

A signal concerning a supply amount of the water 27 determined by the monitoring person on the basis of the notification is sent to the water supply unit 20c via the monitor 47.

The water supply unit 20c receives the signal, opens a control valve 20d (20), and supplies the water 27 to the kneading machine 14 by the determined supply amount.

Note that the moisture amount of the kneaded body 13 may be adjusted by supplying the molding adjuvant 12.

The line 38 may be connected to, for example, the motor 29 of the kneading impeller 43 to adjust an operation time of the motor 29 (i.e., a kneading time).

For example, even when the water content of the kneaded body 13 is too high, it is not easy to draw off only the water 27 from the kneaded body 13.

Accordingly, the water content of the kneaded body 13 is adjusted to be within a predetermined range by increasing the kneading time to vaporize the water 27.

The water content may be adjusted by connecting the line 38 to a power supply 35a (35) and reducing the cooling of the first cooling unit 35 to vaporize the moisture of the kneaded body 13.

Note that, naturally, the adjustment can also be automatically performed not via the monitoring person by connecting the line 38 to the motor 29, the power supply 35a, the control valve 20d, or the like.

Referring back to FIG. 2, the explanation of the manufacturing apparatus 10 is continued.

The kneaded body 13 generated by the kneading machine 14 is extrusion-molded by an extrusion molding machine 18.

The extrusion molding machine 18 includes the hollow tank 15 that has the mold hole 17 and houses the kneaded body 13 and the extruding unit 16 that extrudes the kneaded body 13 from the mold hole 17 of the hollow tank 15 and molds the kneaded body 13.

The generated kneaded body 13 is discharged from the outlet 19 of the kneading machine 14 and drops to an inlet 34 of the hollow tank 15.

The dropped kneaded body 13 is extruded from the mold hole 17 of the hollow tank 15 by the extruding unit 16 and becomes the extrusion-molded body 13a (13).

The extruding unit 16 is, for example, a screw provided inside the hollow tank 15 and rotated by a driving unit 24.

As in the kneading machine 14, in the extrusion molding machine 18, a second cooling unit 51 that cools the hollow tank 15 is provided.

Like the first cooling unit 35, the second cooling unit 51 prevents a rise in temperature due to nuclear decay or frictional heat due to the rotation of the extruding unit 16.

For example, deformation of the mold hole 17, deterioration of the extruding unit 16, and excessive vaporization of the moisture of the kneaded body 13 can be prevented by the second cooling unit 51.

The cutting unit 22 cuts the extrusion-molded body 13a at a specified interval.

Near the distal end of the mold hole 17 of the extrusion molding machine 18, for example, a molding conveyor 42a (42) that conveys the extrusion-molded body 13a is arranged.

The extrusion-molded body 13a discharged from the mold hole 17 is cut in a block shape by the cutting unit 22, a cutting blade 22a of which is arranged perpendicularly to the molding conveyor 42a, and conveyed to a drying machine 28.

Note that the molding conveyor 42a is desirably a conveyor made of metal that is less deteriorated by radiation irradiation compared with a conveyor made of rubber.

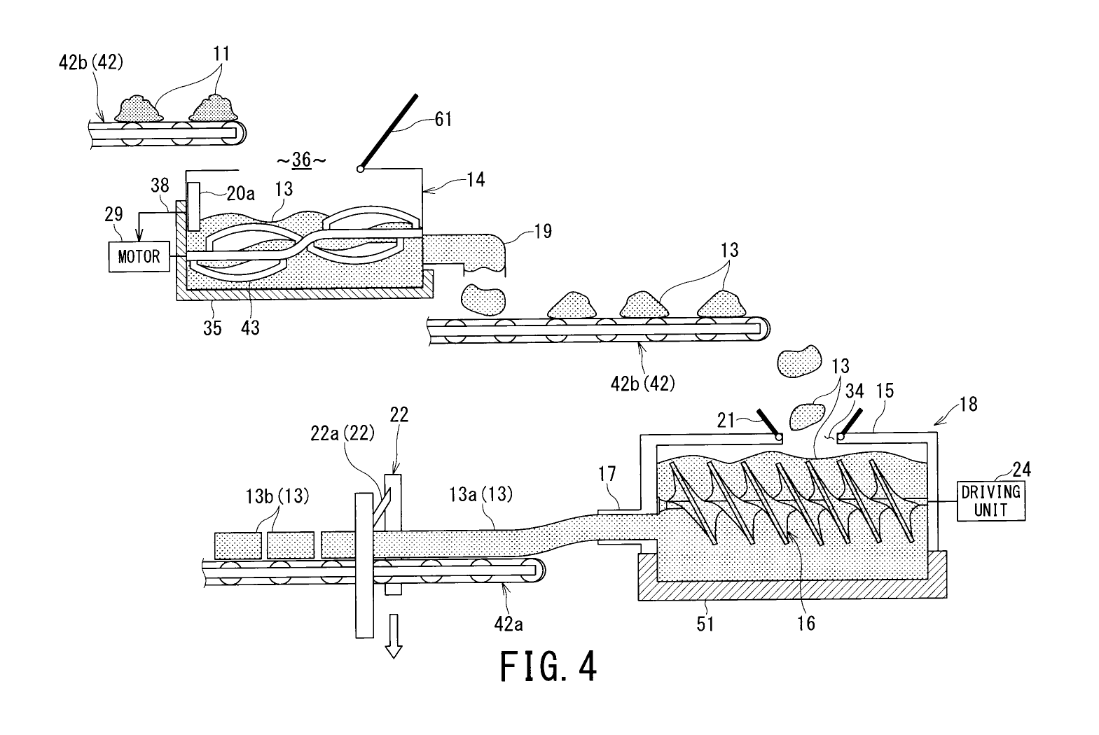

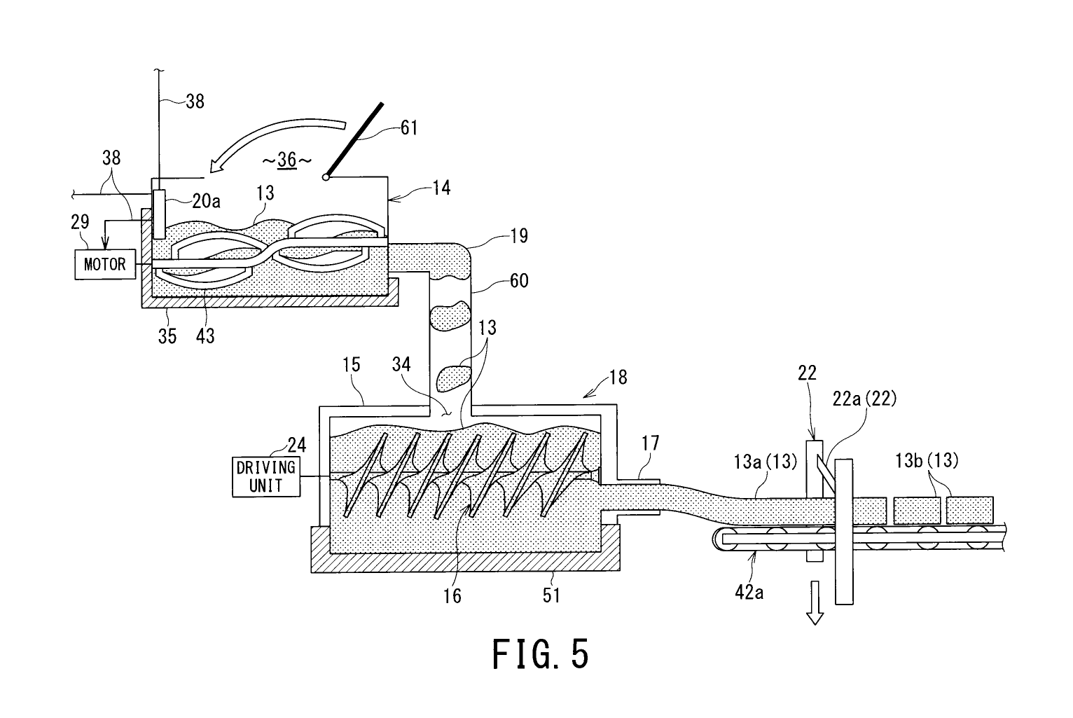

A modification of the kneading machine 14 shown in FIG. 2 and various members connected to the kneading machine 14 will be explained with reference to FIGS. 4 and 5.

Note that, in FIGS. 4 and 5, the water 27, the inorganic adsorbent 11, and the molding adjuvant 12 shown in FIG. 2 are not shown.

The outlet 19 of the kneading machine 14 does not have to be always arranged right above the inlet 34 of the extrusion molding machine 18 as shown in FIG. 2.

For example, depending on a positional relation between the kneading machine 14 and the extrusion molding machine 18, as shown in FIG. 4, the kneading machine 14 and the extruding machine 18 may be connected via a transportation conveyor 42b (42).

Similarly, the vessels 26 and the kneading machine 14 may be connected by the transportation conveyor 42b.

By connecting the members using the conveyor 42 in this way, even if the members are separately arranged because of a problem in design or the like, the solidified body 13c can be continuously manufactured without manual work of an operator.

As shown in FIG. 5, the outlet 19 and the inlet 34 may be directly connected via a pipe 60 by welding or the like.

By directly connecting the outlet 19 and the inlet 34 via the pipe 60, it is possible to prevent the outside air from intruding into the extrusion molding machine 18 every time the inlet 34 is opened.

That is, even if the kneaded body 13 is continuously supplied to the extrusion molding machine 18, the outside air does not intrude from a gap between the outlet 19 and the inlet 34. Decompression of the extrusion molding machine 18 explained in details in a third embodiment is facilitated.

Referring back to FIG. 1, the explanation is continued.

The drying machine 28 houses the cut body 13b for several hours to several days and dries the cut body 13b.

For heating in the drying machine 28, spontaneous heat based on nuclear decay of the radionuclides contained in the organic adsorbent 11 can be used.

The inorganic adsorbent 11 is housed in, for example, the most upstream vessel 26 having a high absorption rate of radionuclides as explained above.

The cut body 13b including the inorganic adsorbent 11 constantly generates heat.

Accordingly, even if a heating unit is not used in the drying machine 28, it is possible to raise the temperature of the drying machine 28 with the spontaneous heat of the cut body 13b and dry the cut body 13b.

The temperature, however, may be accurately controlled by heating the drying machine 28 with a first heater 52 set in the drying machine 28 in addition to the spontaneous heat.

As a method of drying treatment, it is possible to use a so-called batch treatment system for, for example, heating the cut body 13b after housing the cut body 13b in the drying machine 28 with a robot arm 41 set in the drying machine 28.

The drying treatment can also be performed in a continuous treatment system by inserting the conveyor 42 to the inside of the drying machine 28 and increasing path length of the conveyor 42 on the inside.

A baking furnace 23 bakes the cut body 13b into the solidified body 13c.

In the baking furnace 23, the air is used as an atmosphere and the cut body 13b is baked for one to five hours.

A setting temperature of the baking furnace 23 is set in a range of 700° C. to 900° C.

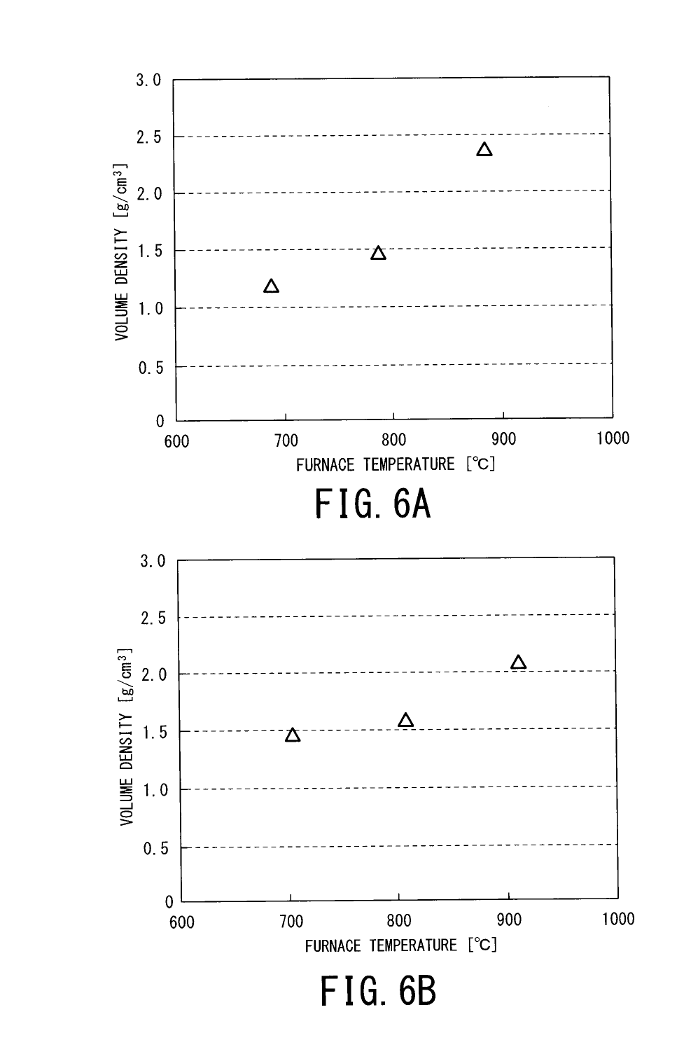

FIG. 6A is a diagram showing an experiment result obtained by measuring density of the cut body 13b, for which chabazite is used as the inorganic adsorbent 11, using a retention temperature during the baking as a variable.

FIG. 6B is a diagram showing an experiment result obtained by measuring density of the cut body 13b, for which crystalline silicon titanate is used as the inorganic adsorbent 11, using the retention temperature during the baking as a variable.

In both of FIGS. 6A and 6B, it is seen that the density of the inorganic adsorbent 11 can be increased to 1.2 to 2.4 g/cm3 by baking the cut body 13b at the retention temperature of 700° C. to 900° C.

On the other hand, if the setting temperature is lower than 700° C., the solidified body 13c obtained by baking the cut body 13b cannot be set to density for giving sufficient compression strength.

If the setting temperature is higher than 900° C., a chloride of ¹³⁷Cs having a relatively low melting point/boiling point vaporizes and scatters.

That is, it is seen that, by setting the setting temperature of the baking furnace 23 in the range of 700° C. to 900° C., it is possible to obtain the solidified body 13c having sufficient strength and density without volatilizing ¹³⁷Cs.

The baked solidified body 13c is housed and stored in a storage container 55 by, for example, the robot arm 41 after weight and a surface radiation dose of the solidified body 13c are measured.

Further, similarly, weight and a surface radiation dose of the storage container 55, which houses the solidified body 13c, are measured.

The weights and the surface radiation doses are thereafter used for management of the solidified body 13c.

Note that, among the members explained above, in particular, members having high temperatures such as the kneading impeller 43, the extruding unit 16, the mold hole 17, and the molding conveyor 42a are desirably formed of wear resistant metal.

The wear resistant metal is, for example, metal coated with a nickel-chrome base alloy, tungsten carbide, or the like having high hardness.

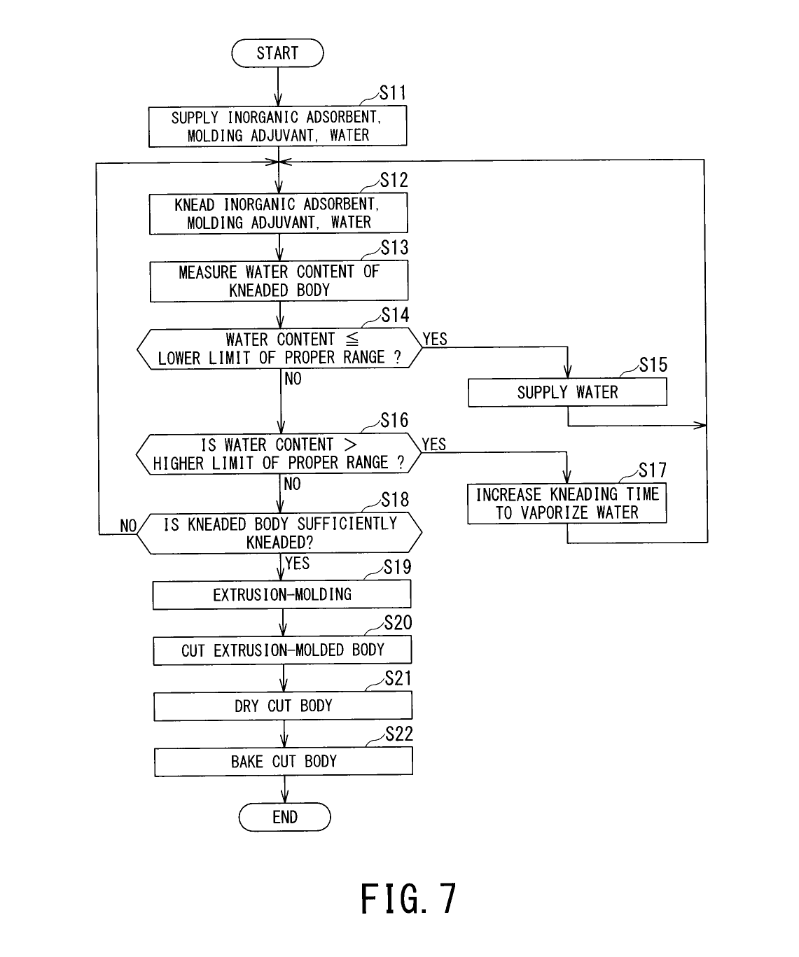

A manufacturing method according to the first embodiment will be explained in detail with reference to FIG. 7 (see FIGS. 1 and 2 as appropriate).

FIG. 7 is a flowchart of a method for manufacturing a solidified body of a radioactive waste (hereinafter simply referred to as “manufacturing method”) according to the first embodiment.

First, a supply valve 56 and the control valve 20d are opened to supply the inorganic adsorbent 11, the molding adjuvant 12, and the water 27 to the kneading machine 14 (S11).

As explained above, when the inorganic adsorbent 11 excessively contains moisture, new supply of the water 27 does not have to be performed.

An opening 36 is closed by a lid section 61 and the inorganic adsorbent 11. The inorganic adsorbent 11, the molding adjuvant 12, and the water 27 are kneaded (S12).

In the kneading, a water content of the kneaded body 13 being kneaded is measured by the measuring unit 20a continuously or at every fixed time (S13).

If the measured water content is equal to or lower than a lower limit of a proper range (YES in S14), the water 27 is supplied from the water supply unit 20c (S15) to knead the inorganic adsorbent 11, the molding adjuvant 12, and the water 27 again (to S12).

If the water content is equal to or higher than an upper limit of the range (NO in S14 and YES in S16), for example, the kneading time is increased to vaporize the water 27 (S17: to S12).

Note that the adjustment of the water content may be determined by the monitoring person who performs monitoring in the control room 46 or may be automatic control of the motor 29, the water supply unit 20c, and the like based on a measurement value.

The kneading and the adjustment are repeated until the kneaded body 13 has a proper water content and appropriate viscosity (S14: NO, S16: NO, S18: NO; to S12).

The kneaded body 13 sufficiently kneaded (YES in S18) is put in the hollow tank 15 of the extrusion molding machine 18 and extrusion-molded (S19).

After the kneaded body 13 is put, a hollow portion of the hollow tank 15 is sealed by a lid section 21.

In the atmosphere decompressed by the vacuum pump 33, the extrusion molding is performed while air bubbles of the kneaded body 13 are removed.

The extrusion-molded body 13a is cut by the cutting unit 22 at a specified interval (S20).

The cut body 13b is dried by the drying machine 28 (S21).

Note that, as explained above, for the drying of the cut body 13b, spontaneous heat based on nuclear decay of the radionuclides contained in the organic adsorbent 11 can be used.

Naturally, in addition to the spontaneous heat, the temperature of the drying machine 28 may be controlled by heating the drying machine 28 with the first heater 52.

The cut body 13b is baked in the baking furnace 23 for one to five hours (S22).

A baking temperature at this time is in a range of 700° C. to 900° C.

The baked solidified body 13c is housed and stored in the storage container 55 after weight and a surface radiation dose of the solidified body 13c are measured.

Further, similarly, weight and a surface radiation dose of the storage container 55 are also measured.

The weights and the surface radiation doses are thereafter used for management of the solidified body 13c.

As explained above, with the manufacturing method according to the first embodiment, it is possible to perform stable final disposal of a large amount of radionuclides with a simple process. Further, it is possible to manufacture the solidified body 13c of radionuclides while suppressing volatilization of the radionuclides in the manufacturing.

With the manufacturing apparatus 10 according to the first embodiment, it is possible to efficiently carry out the manufacturing method.

### Second Embodiment

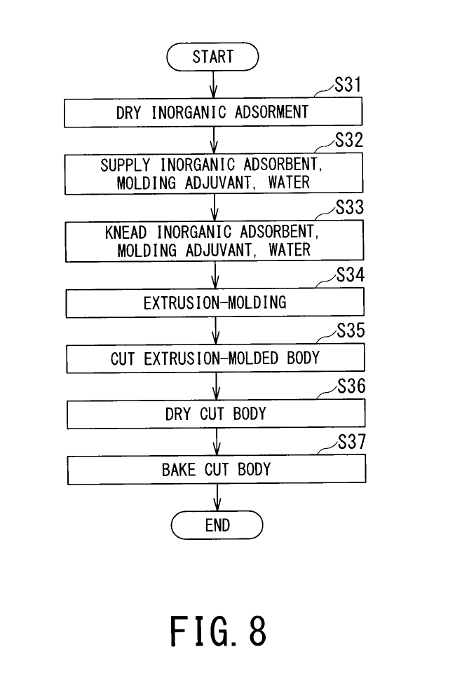

FIG. 8 is a flowchart of a manufacturing method according to a second embodiment.

FIG. 9 is a schematic configuration diagram of the manufacturing apparatus 10 according to the second embodiment.

In the manufacturing method according to the second embodiment, as shown in FIG. 8, an adjusting step includes a drying step (S31) for drying the inorganic adsorbent 11 at a pre-stage of the kneading step (S33) and a proportionally supplying step (S32) for supplying the dried inorganic adsorbent 11, the water 27, and the molding adjuvant 12 at a fixed ratio.

In order to implement such a manufacturing method, the adjusting unit 20 of the manufacturing apparatus 10 according to the second embodiment includes, as shown in FIG. 9, an adsorbent drying unit 20h (20) that dries the inorganic adsorbent 11 before being supplied to the kneading machine 14.

As explained in the first embodiment, the inorganic adsorbent 11 to be kneaded often adsorbs sufficient radionuclides and has high radioactivity.

Accordingly, in order to minimize access of an operator to the vicinity of the manufacturing apparatus 10, the manufacturing apparatus 10 and the manufacturing method need to be configured in a simple structure and control having a low frequency of failure or inspection.

In order to efficiently treat the inorganic adsorbent 11 generated in a large amount, it is desirable to adopt a continuous treatment system as a most part of the manufacturing method.

Accordingly, the manufacturing method desirably involves steps that do not need fine control, which depends on an initial state of the inorganic adsorbent 11, halfway in the continuous treatment as much as possible.

Accordingly, in the second embodiment, at the pre-stage of the kneading step (S33), first, in the drying step (S31), the inorganic adsorbent 11 is dried by the adsorbent drying unit 20h.

For example, if the inorganic adsorbent 11 is completely dried, a difference in a water content of the inorganic adsorbent 11 before the kneading does not affect a water content of the kneaded body 13 after the kneading.

The dried inorganic adsorbent 11 is collected in the adsorbent hopper 31 and supplied to the kneading machine 14 by a fixed amount at a time by a hopper valve 31a (31).

If the water 27 and the molding adjuvant 12 are supplied to the inorganic adsorbent 11 by a fixed amount at a time (S32), it is possible to accurately set a supply ratio of the components of the kneaded body 13 before the kneading.

According to the adjusting step, it is possible to accurately adjust the water content of the kneaded body 13 before the kneading. Accordingly, it is unnecessary to set the measuring unit 20a (FIG. 2) in the kneading machine 14.

Further, it is possible to adjust the water content with uniform control irrespective of a moisture amount of the inorganic adsorbent 11 before the adjusting step.

Such adjustment, however, may be performed in addition to the measuring unit 20a set in the kneading machine 14.

Note that, in the drying step (S31), as in the cut body drying step (S21), it is desirable to use spontaneous heat based on nuclear decay of the radionuclides included in the inorganic adsorbent 11.

Naturally, as in the drying machine 28, the adsorbent drying unit 20h may be heated by a second heater 57 to control the temperature of the adsorbent drying unit 20h in addition to the spontaneous heat.

Note that, in the second embodiment, a structure and an operation procedure are the same as the structure and the operation procedure in the first embodiment except that the adjusting step involves the proportionally supplying step (S32) and the drying step (S31). Accordingly, redundant explanation of the structure and the operation procedure is omitted.

In the figures, components having the same configurations or functions are denoted by the same reference numerals and signs and redundant explanation of the components is omitted.

A molding step (S34) to a baking step (S37) in FIG. 8 are the same as the molding step (S19) to the baking step (S22) in the first embodiment.

In this way, with the manufacturing method according to the second embodiment, in addition to the effects of the first embodiment, it is possible to generate the kneaded body 13 having an accurate water content without checking and adjusting the water content of the kneaded body 13 in the kneading step (S33).

Further, it is possible to adjust the water content with uniform control irrespective of a moisture amount of the inorganic adsorbent 11 before the adjusting step.

As a result, failure or inspection of the measuring unit 20a (FIG. 2) does not have to be taken into account and the manufacturing method is simplified. Accordingly, it is possible to easily execute the manufacturing method in a continuous processing system.

### Third Embodiment

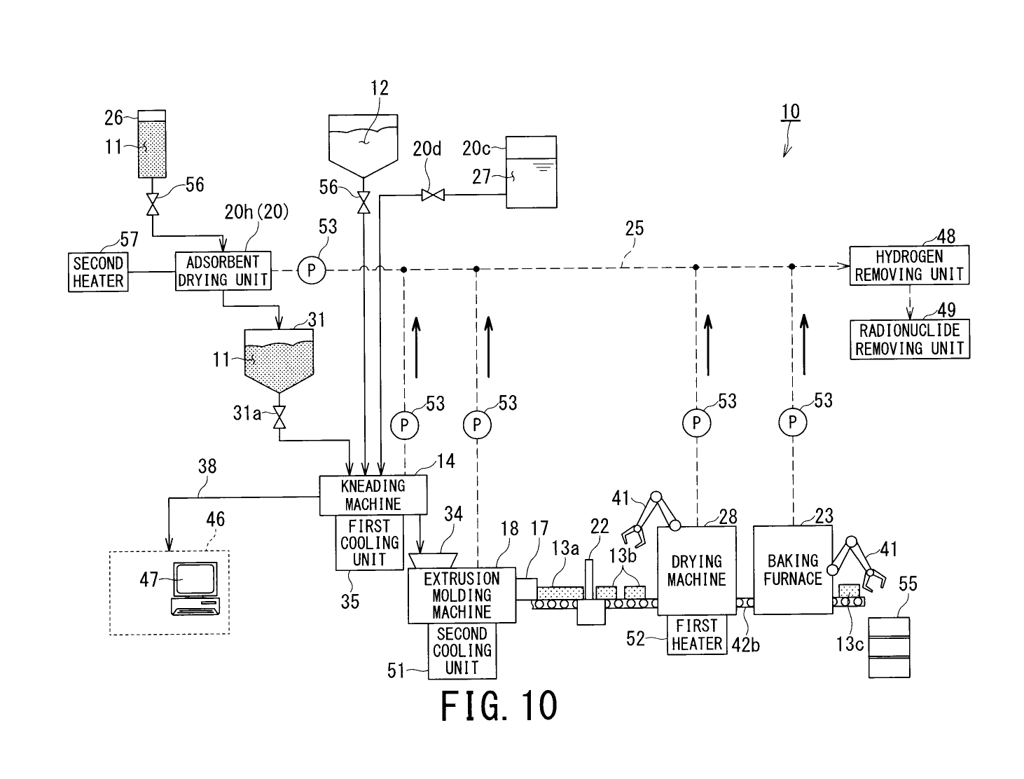

FIG. 10 is a schematic configuration diagram of the manufacturing apparatus 10 according to a third embodiment.

In a manufacturing method according to the third embodiment, generated hydrogen is removed in at least one step of the drying step (S31), the kneading step (S12 to S18 and S33), the molding step (S19 and S34), the cut body drying step (S21 and S36), and the baking step (S22 and S37) in the first embodiment or the second embodiment.

The inorganic adsorbent 11 or the kneaded body 13 in the adsorbent drying unit 20h, the kneading machine 14, the extrusion molding machine 18, the drying machine 28, and the baking furnace 23 contains moisture.

The moisture may be dissolved by radiation of radionuclides adsorbed by the inorganic adsorbent 11 and generate hydrogen on the inside of the kneading machine 14.

In all of the adsorbent drying unit 20h, however, the kneading machine 14, the extrusion molding machine 18, the drying machine 28, and the baking furnace 23, in order to prevent scattering of the radionuclides, opening parts are closed during processing thereof.

Accordingly, the generated hydrogen is held up on the insides of these members.

In order to prevent explosion of the hydrogen held up and increased in density, as shown in FIG. 10, exhaust pipes 25 are provided for these members.

The exhaust pipes 25 are connected to a hydrogen removing unit 48 such as an absorption catalyst of platinum, palladium, or the like that removes hydrogen flowing through the exhaust pipes 25.

Further, an exhaust port of the hydrogen removing unit 48 is connected to a radionuclide removing unit 49 that adsorbs radionuclides.

The radionuclide removing unit 49 is, for example, an HEPA filter or a charcoal filter formed of activate charcoal.

With the hydrogen removing unit 48 and the radionuclide removing unit 49, it is possible to prevent explosion due to the hydrogen of the kneading machine 14 without scattering the radionuclides to the outside of the members.

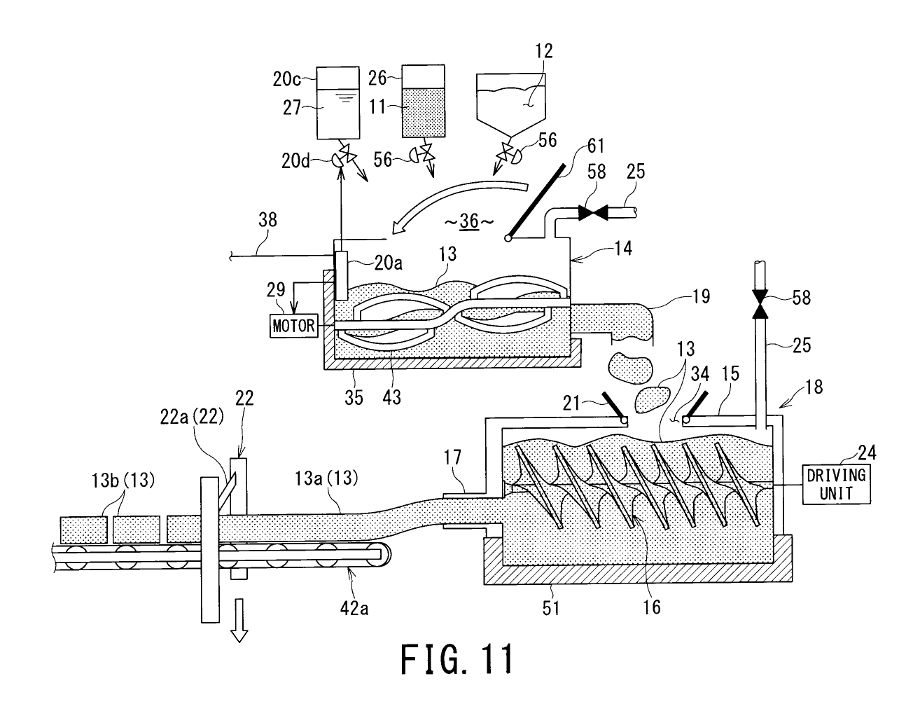

FIG. 11 is a schematic sectional view showing an example of the arrangement of the kneading machine 14 and the exhaust pipes 25 in the extrusion molding machine 18.

Hydrogen atoms are light. Gaseous hydrogen rises and is held up in the vicinity of the upper surfaces of the members.

Accordingly, as shown in FIG. 11, the exhaust pipes 25 are preferably provided on the upper surfaces or in as high a part as possible of a gas phase portion.

Exhaust valves 58 provided in the exhaust pipe 25 are opened during treatment of the respective members such as kneading. The hydrogen is discharged together with other gases.

Note that the exhaust pipes 25 are not limited to be integrated in one hydrogen removing unit 48 shown in FIG. 10 and may be independently provided from one another.

Hydrogen removing units 48 and radionuclide removing units 49 may be set in the respective exhaust pipes 25.

Exhaust pumps 53 that forcibly discharge gas on the inside of the kneading machine 14 may be provided in the respective exhaust pipes 25.

When, for example, the inside of the kneading machine 14 is decompressed by the exhaust pump 53, mixing of gas in the kneaded body 13 by the kneading can also be suppressed.

By suppressing the mixing of the gas, it is easier to remove air bubbles in the extrusion molding machine 18 explained in detail in a fourth embodiment.

When a generation amount of hydrogen is large, it is possible to more surely discharge held-up hydrogen.

Note that, in the third embodiment, a structure and a manufacturing process are the same as the structure and the manufacturing process in the first embodiment or the second embodiment except that hydrogen is removed in the steps and the members by the exhaust pipe 25 and the hydrogen removing unit 48. Accordingly, redundant explanation of the structure and the manufacturing process is omitted.

In the figures, components having the same configurations or functions are denoted by the same reference numerals and signs and redundant explanation of the components is omitted.

As explained above, with the manufacturing method or the manufacturing apparatus 10 according to the third embodiment, in addition to the effects of the first embodiment and the like, it is possible to prevent explosion due to hydrogen generated in the steps.

By decompressing the inside of the kneading machine 14 with the exhaust pipe 25, it is possible to reduce mixing of air bubbles in the kneaded body 13.

### Fourth Embodiment

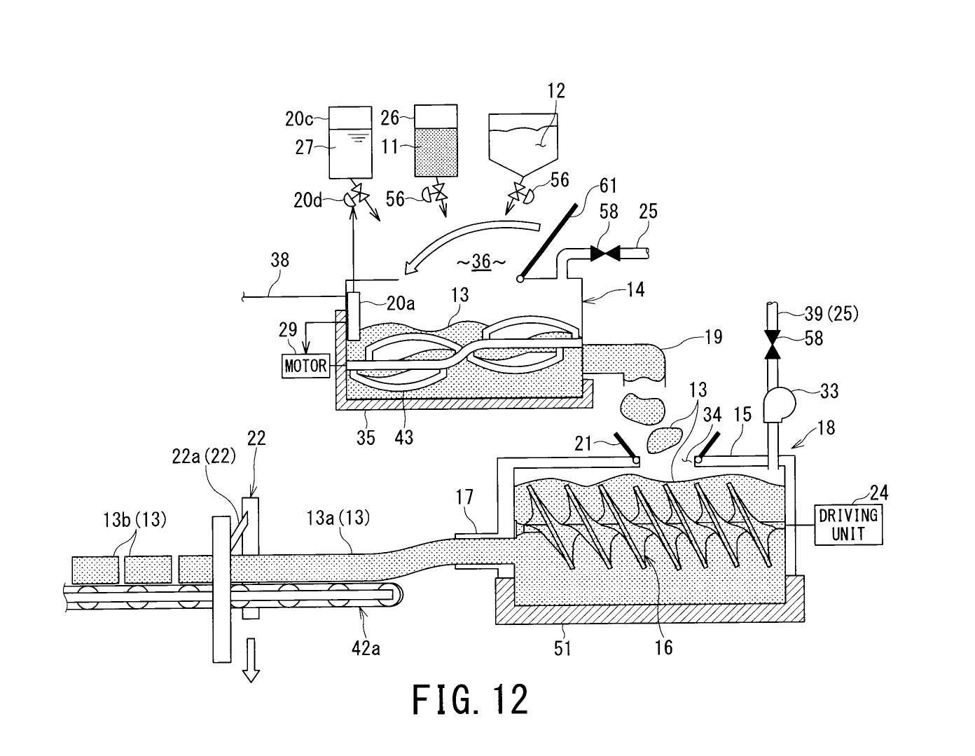

FIG. 12 is an enlarged sectional view of the kneading machine 14 of the manufacturing apparatus 10 according to a fourth embodiment and various members connected to the kneading machine 14.

The manufacturing apparatus 10 according to the fourth embodiment includes, as shown in FIG. 12, in the hollow tank 15, an intake pipe 39 in which a vacuum pump 33 is set.

The intake pipe 39 may be used as the exhaust pipe 25 as well as shown in FIG. 12.

The vacuum pump 33 is, however, set in the intake pipe 39. The inside of the hollow tank 15 is more surely decompressed by the vacuum pump 33 than the other exhaust pipe 25.

When the kneaded body 13 is put in the hollow tank 15, the inlet 34 of the hollow tank 15 is closed by the lid section 21. The hollow portion of the hollow tank 15 is sealed.

The hollow portion is decompressed to nearly vacuum by the vacuum pump 33 and extrusion molding is performed.

By molding the kneaded body 13 under a decompressed atmosphere, fine air bubbles included in the kneaded body 13 are removed.

Note that, in the fourth embodiment, a structure and a manufacturing process are the same as the structure and the manufacturing process in the first embodiment to the third embodiment except that the inside of the hollow tank 15 is decompressed by the intake pipe 39 and the vacuum pump 33. Accordingly, redundant explanation of the structure and the manufacturing process is omitted.

In the figures, components having the same configurations or functions are denoted by the same reference numerals and signs and redundant explanation of the components is omitted.

As explained above, with the manufacturing apparatus 10 according to the fourth embodiment, since air bubbles are removed, in addition to the effects of the first embodiment, it is possible to reduce the volume of the extrusion-molded body 13a molded by extruding the kneaded body 13. Further, it is possible to suppress a crack.

### Example 1

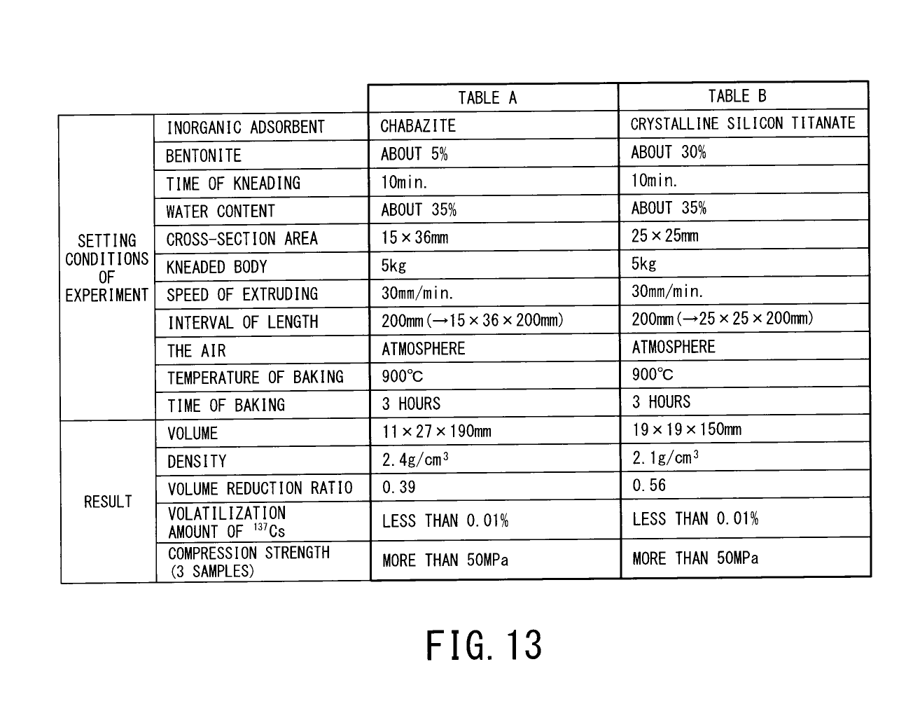

An example concerning the solidified body 13c of radioactive wastes according to an embodiment will be explained with reference to FIG. 13.

FIG. 13 is a table showing experiment data obtained by manufacturing the solidified body 13c by kneading the molding adjuvant 12, which is bentonite, with the inorganic adsorbent 11.

A Table A in FIG. 13 is experiment data obtained when chabazite was used as a main component of the inorganic adsorbent 11.

First, the inorganic adsorbent 11 containing chabazite as the main component was dried until a water content decreased to 0%.

Bentonite of about 5% of the inorganic adsorbent 11 and the water 27 of about 40% of the entire mass of the inorganic adsorbent 11 were added to the inorganic adsorbent 11. The inorganic adsorbent 11 added with the bentonite and the water 27 was kneaded by the kneading machine 14 for about ten minutes to manufacture the kneaded body 13.

A moisture amount of the kneaded body 13 after the kneading was about 35%.

Subsequently, the rectangular mold hole 17 having dimensions of 15×36 mm was attached to the extrusion molding machine 18. The kneaded body 13 of about 5 kg was put in the extrusion molding machine 18.

Extrusion speed was set to 30 mm/minute. The kneaded body 13 was extrusion-molded from the mold hole 17 while being kneaded by a screw.

The continuous plate bar-like extrusion-molded body 13a having a cutting plane having dimensions of 15×36 mm was obtained by the extrusion molding.

The extrusion-molded body 13a was cut by the cutting unit 22 at an interval of length of about 200 mm to obtain the cut body 13b having dimensions of 15×36×200 mm.

The cut body 13b was retained in an electric furnace, in which the air is an atmosphere, at 900° C. for three hours and baked.

As a result, dimensions of the baked solidified body 13c were 11×27×190 mm, a volume reduction ratio (=volume of the baked solidified body 13c/volume of material powder) of the solidified body 13c was 0.39, density of the solidified body 13c was 2.4 g/cm3, and a volatilization amount of ¹³⁷Cs was equal to or smaller than 0.01% (not detected).

All of three test pieces sampled from the solidified body 13c indicated measured compression strength equal to or higher than 50 MPa. An increase in strength due to solidification was confirmed.

### Example 2

The same demonstration experiment was performed for the inorganic adsorbent 11 containing crystalline silicon titanate as a main component. A result indicated by a Table B of FIG. 13 was obtained.

An amount of bentonite, however, which is the molding adjuvant 12, was set to about 30% of the inorganic adsorbent 11.

This is because, since the crystalline silicon titanate has low viscosity compared with chabazite, a larger amount of the bentonite was added to prevent a crack in the extrusion molding.

In order to prevent a crack in the extrusion molding, the cutting plane was devised to be formed in a square shape of 25×25 mm.

This is because, by forming the cutting plate in the square shape, compared with a load applied when the cutting plate is formed in a rectangular shape, a load is isotropically applied and a crack can be presented.

Note that setting conditions other than the conditions explained above are set the same as the setting conditions of the experiment performed for the inorganic adsorbent 11 containing the chabazite as the main component.

That is, a kneading time was set to ten minutes, a moisture content of the kneaded body 13 after the kneading was set to about 35%, an amount of the kneaded body 13 put in the extrusion molding machine 18 was set to 5 kg, extrusion speed was set to 30 mm/minute, the cut body 13b was manufactured with length of cutting set to 200 mm, and the cut body 13b was retained in an electric furnace, in which the air was an atmosphere, at 900° c. for three hours.

As a result, dimensions of the solidified body 13c were 19×19×150 mm, density of the solidified body 13c was 2.1 g/cm3, a volume reduction ratio of the solidified body 13c to material powder was 0.56, and a volatilization amount of ¹³⁷Cs was equal to or smaller than 0.01% (not detected).

All of three test pieces sampled from the solidified body 13c indicated measured compression strength equal to or higher than 50 MPa. An increase in strength due to solidification was confirmed.

It was verified from the example 1 and the example 2 explained above that, in the extrusion-molded body 13a manufactured by adding the bentonite to the inorganic adsorbent 11 containing the chabazite or the crystalline silicon titanate as the main component, a decrease in the volume as well as a decrease in the volume reduction ratio and an increase in the density were observed and the compression strength was increased to 50 MPa or more.

### Example 3

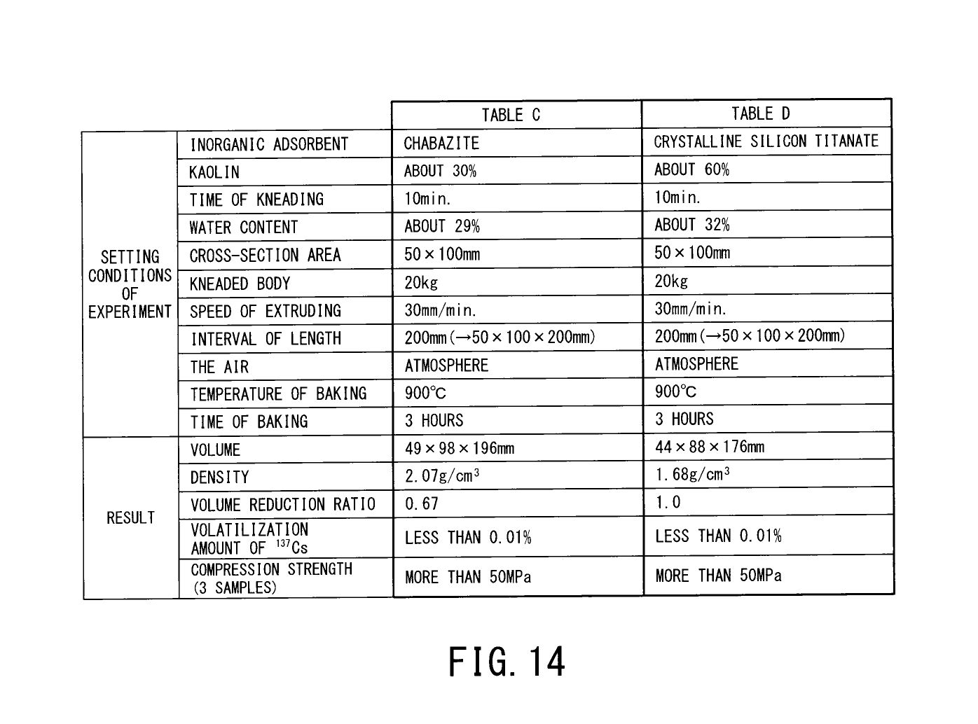

As shown in FIG. 14, an example in which the inorganic adsorbent 11 was chabazite and crystalline silicon titanate and the molding adjuvant 12 was kaolin is illustrated.

Like the bentonite, the kaolin is inexpensively easily available, is unlikely to be dissolved by radiation, and can be suitably used for manufacturing of the solidified body 13c of the radioactive wastes.

FIG. 14 is a table showing experiment data obtained by manufacturing the solidified body 13c by kneading the molding adjuvant 12, which is the kaolin, with the inorganic adsorbent 11.

A Table C and a Table D in FIG. 14 are respectively experiment data obtained when the chabazite and the crystalline silicon titanate are used as the inorganic adsorbent 11.

Note that, in the example 2, a structure and a manufacturing process are the same as the structure and the manufacturing process in the example 1 except that the molding adjuvant 12 is the kaolin and a mixing ratio of the kaolin is set larger than the mixing ratio of the bentonite. Accordingly, redundant explanation is omitted.

Portions having the same configurations or functions explained with reference to the figure are denoted by reference numerals and signs same as the reference numerals and signs of the portions explained with reference to FIG. 13.

First, experiment data of the Table C shown in FIG. 14 will be explained.

The kaolin of about 30% of the inorganic adsorbent 11 and an appropriate amount of the water 27 were added to the inorganic adsorbent 11 containing the chabazite as a main component. The inorganic adsorbent 11 added with the kaolin and the water 27 was kneaded by the kneading machine 14 for about ten minutes to manufacture the kneaded body 13.

A moisture content of the kneaded body 13 after the kneading was about 29%.

Subsequently, the rectangular mold hole 17 having dimensions of 50×100 mm was attached to the extrusion molding machine 18. The kneaded body 13 of about 20 kg was put in the extrusion molding machine 18.

Extrusion speed was set to 30 mm/minute. The kneaded body 13 was extrusion-molded from the mold hole 17 while being kneaded by a screw.

The continuous plate bar-like extrusion-molded body 13a having a cutting plane having dimensions of 50×100 mm was obtained by the extrusion molding. The extrusion-molded body 13a was cut by the cutting unit 22 at an interval of length of about 200 mm to obtain the extrusion-molded body 13a having dimensions of 50×100×200 mm.

The manufactured extrusion-molded body 13a was retained in an electric furnace, in which the air is an atmosphere, at 900° C. for three hours and baked.

As a result, dimensions of the solidified body 13c were 49×98×196 mm, a volume reduction ratio of the solidified body 13c was 0.67, density of the solidified body 13c was 2.07 g/cm3, and an volatilization amount of ¹³⁷Cs was equal to or smaller than 0.01% (not detected).

All of three test pieces sampled from the solidified body 13c indicated measured compression strength equal to or higher than 50 MPa. An increase in strength due to solidification was confirmed.

Note that a difference from the experiment data of the embodiment shown in the Table A of FIG. 13 is that an amount of the added kaolin is large at 30% compared with the amount of the bentonite added to the inorganic adsorbent 11.

This indicates that the kaolin has low viscosity compared with the bentonite. According to an increase in the molding adjuvant 12 to be added, the volume reduction ratio after the baking is slightly high at 0.67.

The volume reduction ratio is, however, equal to or lower than 1.0, which is an sufficiently allowable value.

The cutting plane is set to the dimensions of 50×100 mm. The extrusion-molded body 13a is cut by the cutting blade 22a of the cutting unit 22 at length of 200 mm. Dimensions of the extrusion-molded body 13a is set to 50×100×200 mm.

Dimensions can be freely determined as long as the dimensions are equal to or smaller than the dimensions of 50×100×200 mm. A difference due to the dimensions hardly affects a result of the experiment.

### Example 4

The same demonstration experiment was performed for the inorganic adsorbent 11 containing crystalline silicon titanate as a main component. A result indicated by the Table D of FIG. 14 was obtained.

An amount of kaolin was, however, set to about 60% of the inorganic adsorbent 11.

This is because, since the crystalline silicon titanate has low viscosity compared with chabazite, a larger amount of the kaolin was added to prevent a crack in the extrusion molding.

Because of the same reason, a moisture amount of added water was slightly large at 32%.

Note that setting conditions other than the setting conditions explained above are set the same as the setting conditions of the experiment performed for the inorganic adsorbent 11 containing the chabazite as the main component.

That is, a kneading time was set to ten minutes, a moisture content of the kneaded body 13 after the kneading was set to 35%, an amount of the kneaded body 13 put in the extrusion molding machine 18 was set to 20 kg, extrusion speed was set to 30 mm/minute, the extrusion-molded body 13a was manufactured with the dimensions of 50×100×200 mm, and the extrusion-molded body 13a was retained in an electric furnace, in which the air was an atmosphere, at 900° c. for three hours.

As a result, dimensions of the solidified body 13c were 44×88×176 mm, density of the solidified body 13c was 1.68 g/cm3, a volume reduction ratio of the solidified body 13c was 1.0, and a volatilization amount of ¹³⁷Cs was equal to or smaller than 0.01% (not detected).

All of three test pieces sampled from the solidified body 13c indicated measured compression strength equal to or higher than 50 MPa. An increase in strength due to solidification was confirmed.

It was verified from the example 3 and the example 4 explained above that, even when the kaolin is the molding adjuvant 12, effects equivalent to the effects obtained when the bentonite was the molding adjuvant 12 in the embodiment were obtained.

It was verified according to the embodiments explained above that the solidified body 13c manufactured by the manufacturing methods according to the embodiments had pressure strength and a volume reduction ratio sufficient for long-term storage and ¹³⁷Cs was not volatilized in the manufacturing.

Several embodiments are explained above. The embodiments are, however, presented as examples and are not intended to limit the scope of the invention.

The embodiments can be implemented in other various forms. Various omissions, replacements, changes, and combinations of the embodiments can be performed without departing from the spirit of the invention.

The embodiments and modifications of the embodiments are included in the scope and the spirit of the invention and are included in the inventions described in patent claims and the scope of equivalents of the inventions.

With the manufacturing method according to at least one of the embodiments explained above, it is possible to perform stable final disposal of a large amount of radionuclides with a simple process. Further, it is possible to manufacture the solidified body 13c of radionuclides while suppressing volatilization of the radionuclides in the manufacturing of the solidified body 13c.

With the manufacturing apparatus 10 according to at least one of the embodiments explained above, it is possible to efficiently execute the manufacturing method.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for manufacturing a solidified body of a radioactive waste comprising:
a kneading step for kneading, together with a molding adjuvant, an inorganic adsorbent adsorbing a radionuclide to generate a kneaded body;
an adjusting step for adjusting a water content of the kneaded body to be within a predetermined range;
a molding step for molding the kneaded body by extruding;
a cutting step for cutting, at a specified interval, the kneaded body extruded in a bar shape; and
a baking step for baking the cut kneaded body into a solidified body.

2. The method for manufacturing the solidified body of the radioactive waste according to claim 1, wherein the adjusting step is carried out together with the kneading in the kneading step.

3. The method for manufacturing the solidified body of the radioactive waste according to claim 1, wherein the adjusting step includes:
a drying step for drying the inorganic adsorbent at a pre-stage of the kneading step; and
a proportionally supplying step for supplying the dried inorganic adsorbent, water, and the molding adjuvant at a fixed ratio.

4. The method for manufacturing the solidified body of the radioactive waste according to any one of claim 1, further comprising a cut body drying step for drying the kneaded body cut in the cutting step.

5. The method for manufacturing the solidified body of the radioactive waste according to claim 4, wherein, in at least one of the drying step and the cut body drying step, the inorganic adsorbent or the kneaded body is dried by spontaneous heat based on nuclear decay of the radionuclide contained in the inorganic adsorbent.

6. The method for manufacturing the solidified body of the radioactive waste according to any one of claim 1, wherein the molding step is carried out under a decompressed atmosphere.

7. The method for manufacturing the solidified body of the radioactive waste according to claim 4, wherein generated hydrogen is removed in at least one step of the drying step, the kneading step, the molding step, the cut body drying step, and the baking step.

8. The method for manufacturing the solidified body of the radioactive waste according to any one of claim 1, wherein at least one of weight, a surface radiation dose, and a solidified body radiation dose of the solidified body baked and stored in a storage container is measured.

9. A manufacturing apparatus for a solidified body of a radioactive waste comprising:
a kneading machine that kneads an inorganic adsorbent adsorbing a radionuclide and a molding adjuvant to generate a kneaded body;
an adjusting unit that adjusts an amount of water to be kneaded together with the inorganic adsorbent and the molding adjuvant;
a hollow tank that has a mold hole and stores the kneaded body;
an extruding unit that extrudes the kneaded body from the mold hole and molds the kneaded body;
a cutting unit that cuts, at a specified interval, the kneaded body extruded in a bar shape; and
a baking furnace that bakes the cut kneaded body into a solidified body.

10. The manufacturing apparatus for the solidified body of the radioactive waste according to claim 9, wherein the adjusting unit includes a measuring unit that measures a water content of the kneaded body in the kneading machine.

11. The manufacturing apparatus for the solidified body of the radioactive waste according to claim 9, wherein the adjusting unit is an adsorbent drying unit that dries the inorganic adsorbent before being supplied to the kneading machine.

12. The manufacturing apparatus for the solidified body of the radioactive waste according to any one of claim 9, further comprising a drier that dries the cut kneaded body.

13. The manufacturing apparatus for the solidified body of the radioactive waste according to claim 12, wherein at least one of the drier and the baking furnace includes a robot arm that piles up the cut kneaded body.

14. The manufacturing apparatus for the solidified body of the radioactive waste according to claim 12, further comprising a conveyor set in at least one section of sections between the kneading machine and the extruding unit, between the extruding unit and the drier, and between the drier and the baking furnace, the conveyor conveying the kneaded body.
